(19) United States
(12) Patent Application Publication
(10) Pub. No.: US 2012/0068906 A1
(43) Pub. Date: Mar. 22, 2012

(54) PHASED ARRAY ANTENNA AND METHOD FOR PRODUCING THEREOF

(75) Inventors: Menachem ASHER, Kidron (IL); Meir TURGEMAN, Rehovot (IL)

(73) Assignee: ELTA SYSTEMS LTD., ASHDOD (IL)

(21) Appl. No.: 13/252,655

(22) Filed: Oct. 4, 2011

Related U.S. Application Data
(63) Continuation of application No. PCT/IL2010/000224, filed on Mar. 18, 2010.

(30) Foreign Application Priority Data
Apr. 5, 2009 (IL) 197906

(51) Int. Cl. H01Q 21/00; H01P 11/00

(52) U.S. Cl. 343/853; 29/600

(57) ABSTRACT

A vertically stacked array antenna structure is described. The structure comprises a radiating layer, a passive layer disposed under said radiating layer, an active layer disposed under said passive layer, and an interface assembly. The radiating layer comprises an array of radiating elements. The passive layer has only passive components. At least a part of the passive components includes an array of RF duplexers corresponding to the array of radiating elements. The active layer comprises RF amplifiers. The interface assembly comprises at least one metallic frame which is in direct thermal coupling with the RF amplifiers. The interface assembly is configured for providing thermal communication of the active layer with a heat exchanger.

### FIELD OF THE INVENTION

This invention relates to a phased array antenna, and more specifically to a layered, vertically stacked antenna.

### BACKGROUND OF THE INVENTION

Phased array antennas have presented a great leap in the progress of devices associated with electromagnetic radiation, and particularly various RADAR systems. A phased array antenna generally includes an array of radiating elements, each radiating element defines and is associated with an individual Radio-Frequency (RF) transmit/receive (T/R) channel. The term “radiating element” herein is used interchangeably with the term “antenna element”, meaning an element that is configured and operable to radiate and/or receive electromagnetic energy from space. In each such channel the phase and possibly the amplitude of the signal that passes therethrough, can be controlled individually. The proper tuning of phase and amplitude of the signal in each channel of the antenna array provides for great flexibility in the characteristics of the antenna beam. For example, a beam may be steered almost instantaneously to various directions, it may also be constructed to have various shapes, and be split into several directional beams. Likewise, a beam may adopt different cross sections for transmit and receive modes. Furthermore, phased array antennas may feature such flexibility in beam characteristics without any moving antenna parts, thus making them particularly attractive for specific usages like airborne vehicles, or satellites, etc.

Phased array antennas are usually divided into Electronically Steered Antennas, commonly referred to as ESA, and Active Electronically Steered Antennas, commonly referred to as AESA. In ESA, the individual channels that feed the radiating elements do not generally include RF amplifiers, and in the transmit mode the whole array is usually fed from a single power amplifier. Accordingly, distribution of transmitted energy is carried out by a power distribution arrangement functionally located between the single power amplifier and the multitude of radiating elements. In ESA, therefore, the distance from the power amplifier to each of the radiating elements, and configuration of the power distribution arrangement leads to a considerable loss of power. Moreover, ESA may suffer reliability deficiency, because failure in the power amplifier may jeopardize operation of the complete antenna.

Recent progress in semiconductor technology has enabled production of Monolithic Microwave Integrated Circuits (MMIC's). This has made possible the manufacturing of semiconductor-based amplifiers operable in the RF frequency bands and capable of outputting high enough power to feed transmission channels in arrayed antennas. In an AESA, an individual amplifier may thus be incorporated in each channel, potentially providing the AESA with high efficiency of power delivery. Moreover, AESA potentially enables high reliability due to high redundancy, because the antenna as a whole may still function reasonably well if one or even a few channels are neutralized due to failure in their active devices. In some applications, power amplifiers of the transmission channel and pre-amplifiers serving as the first amplification stage in the reception channel, are all integrated into a single package of a Transmit/Receive (T/R) module.

The incorporation of such active T/R modules in the individual channels of arrayed antennas facilitates modular and compact constructions of the array antennas. However, in modular and compact constructions, special attention must be given to heat removal from the active devices, because T/R modules can generate a substantial amount of heat which, if not removed, might lead to temperature rise and eventual damage to the device. Moreover, modularity and compactness may impose certain constraints on RF distribution and interconnection between units of the antenna. Accordingly, these problems should be properly addressed in order to exploit such potential virtues of the AESA as modularity and ease of maintenance.

Slat-based architecture for AESA construction attempts to address these problems. For example, U.S. Pat. No. 7,017,651 to Wilson, et al. describes an apparatus that includes a plurality of T/R modules coupled with a slat assembly that includes a coolant fluid passageway. A plurality of turbulence inducing structures is disposed within the fluid passageway. The location and configuration of the structures is selected to achieve a predetermined temperature profile along the passageway, in response to fluid flow through the fluid passageway. U.S. Pat. No. 7,110,260 to Weber et al. describes an apparatus that includes a heat receiving portion which receives heat within a footprint from a heat generating structure, and a cooling arrangement which causes flow of a coolant that absorbs heat at the heat receiving portion. The cooling arrangement is disposed in its entirety within a width of the footprint in a particular direction.

A layered architecture is a possible alternative to the slat-based architecture described above. For example, U.S. Pat. No. 7,348,932 to Puzella et all, describes a radiator that includes a waveguide having an aperture and a patch disposed in the aperture. An antenna includes an array of waveguide antenna elements, each element having a cavity and an array of patch antenna elements including an upper patch element and a lower patch element disposed in the cavity.

A layered architecture is also described in a paper titled “Architecture and interconnect technologies for a novel conformal active phased array radar module” published in Microwave Symposium Digest, 2003 IEEE MTT-S International pp 567-570, 8-13 Jun. 2003 by M. Schreiner, H. Leier, W. Menzel and H. P. Feldle. The structure of Schreiner et al includes an RF frontend thermally connected to a manifold which includes a cooling structure. The RF frontend is constructed in a layered structure, comprising, from top to bottom, an antenna elements layer, a circulators layer incorporating also low noise amplifiers, digital control layers, and a power amplifier layer. The power amplifier layer is the lowest layer that incorporates also driver amplifiers. In this structure the power amplifiers are placed close to the cooling structure but distant from the antenna elements. This provision imposes separation of the power amplifiers from the low noise amplifiers (mounted in the circulators layer) and thereby disables the integration of the power amplifiers and the low noise amplifiers in unified packages.

Yet another layered design incorporating a cooling plate is described in “T/R-modules technological and technical trends for phased array antennas” by Y. Mancuso, P. Gremillet and P. Lacomme, in European Microwave Conference, 2005 Volume 2, pp. 817-820, 4-6 Oct. 2005. In this structure, the power layer is disposed close to the radiating elements, whereas the cooling plate is disposed between the power layer and the radiating elements.

### GENERAL DESCRIPTION OF THE INVENTION

Despite the cited reference in the area of array antenna structures, there is still a need in the art for further improvement in order to improve modularity and compactness, facilitate maintenance, and allow efficient heat removal from heat generating elements in the structure, while enabling a reliable interconnect scheme to improve the antenna performance.

There is also a need and it would be advantageous to have an array antenna structure that substantially includes integrated and stacked layers.

There is still a need and it would be advantageous to have an array antenna structure that includes a plurality of active electronic components, and in particular RF power amplifiers, which provide for efficient heat removal from these electronic components.

There is a further need and it would be advantageous to have an array antenna structure that includes a relatively simple mounting of the array antenna structure on a heat exchanger. This feature may facilitate a rather simple maintenance of a transceiver device utilizing such an array antenna structure, and provide simple access to and replacement of the components of the antenna.

There is also a need and it would be advantageous to have an array antenna structure in which a substantially all of the RF amplifiers are integrated in the same stacked layer.

The present invention partially eliminates disadvantages of cited reference techniques and provides a novel vertically stacked array antenna structure. The vertically stacked array antenna structure includes a radiating layer comprising an array of radiating elements, and a passive layer disposed under the radiating layer and having only passive components. At least a part of the passive components includes an array of RF duplexers corresponding to the array of radiating elements.

The vertically stacked array antenna structure also includes an active layer disposed under the passive layer and having RF amplifiers. The antenna structure also includes an interface assembly comprising one or more metallic frames. The interface assembly is configured for providing thermal communication of the active layer with a heat exchanger. According to an embodiment, the metallic frame of the interface assembly is in direct thermal coupling with the RF amplifiers.

It should be understood that the broad term “thermal communication” means in this disclosure thermal interfacing, allowing for heat transfer. It should further be understood that “direct thermal coupling” between two elements, one typically being a heat source and the other being a heat sink or a heat transfer medium, refers to a physical contact between these two elements. Direct thermal coupling may further refer to thermal coupling assisted by a heat conducting element, e.g. heat conducting glue or heat conducting paste, or by a layer of heat conducting pad as is described further below, and the like, provided that introducing such heat conducting element enhances and improves the heat conduction, compared to the unassisted physical contact between the two elements. Generally, direct thermal coupling constitutes coupling along a substantial surface area of at least the element which acts as the heat source, thus providing an effective heat transfer from the element being the heat source to the other element.

According to one embodiment, the vertically stacked array antenna structure is mounted on a heat exchanger which thermally communicates with the interface assembly.

According to one embodiment, the vertically stacked array antenna structure comprises the heat exchanger, thermally communicating with the interface assembly.

According to one embodiment, examples of the radiating elements include, but are not limited to, patch antenna elements, strip antenna elements, stacked patch antenna element, microstrip antenna element, horn antenna element, Tapered-Slot Antenna (TSA) element (also known as Vivaldi) and dipole antenna element.

According to one embodiment, the radiating elements are mounted on a radiating elements board. An example of the radiating elements board includes, but is not limited to, a printed circuit board.

According to one embodiment, the passive layer includes a board on which the array of duplexers is arranged. An example of the duplexers board includes, but is not limited to, a printed circuit board.

According to a further embodiment, the array of duplexers includes an array of RF circulators.

According to one embodiment, the active layer comprises a plurality of RF amplifiers.

According to a further embodiment, the plurality of RF amplifiers are in direct thermal coupling with the metallic frame.

According to yet a further embodiment, the plurality of RF amplifiers is selected from transmission RF amplifiers and reception RF amplifiers.

According to another embodiment, the plurality of RF amplifiers is integrated into RF amplifier modules, each RF amplifier module including at least two RF amplifiers.

According to a further embodiment, at least one RF amplifier module comprises at least one transmission RF amplifier and at least one corresponding reception RF amplifier.

According to yet another embodiment, at least one RF amplifier module comprises four pairs of RF amplifiers. Each pair comprises one transmission RF amplifier and one reception RF amplifier, and corresponds to one corresponding duplexer.

According to an embodiment, one or more RF amplifier modules include a phase shifter.

According to one embodiment, the interface assembly includes a first frame and a second frame. The first and second frames are disposed under the passive layer and are thermally coupled to each other.

According to a further embodiment, the active layer is encompassed between the first frame and the second frame.

According to one embodiment, the first frame and the second frame are rigid frames made of thermally conducting materials which are in direct thermal coupling with each other.

According to a further embodiment, at least one frame selected from the first frame and the second frame has a compartment structure comprising at least one compartment. Each compartment defines a cavity in which RF amplifiers are located substantially thereinside. According to an embodiment, the RF amplifiers are in direct thermal coupling with the frame.

According to yet a further embodiment, at least one frame is made from an electrically conducting material.

According to one embodiment, the vertically stacked array antenna structure comprises an antenna frame disposed under the radiating layer. The antenna frame includes holes passing through the antenna frame for RF interconnections.

According to a further embodiment, the antenna frame is metallic.

According to yet a further embodiment, the antenna frame has a compartment structure comprising at least one compartment. Each compartment defines a cavity in which RF duplexers are located substantially thereinside.

According to one embodiment, the vertically stacked array antenna structure comprises a distribution network comprising electric connectors configured to establish electric connection between the array antenna structure and external devices. The distribution network is configured for distribution of electric signals selected from DC supply signal, control signals, transmission RF signals and Reception RF signals.

According to a further embodiment, the distribution network is arranged within the active layer.

According to a further embodiment, the distribution network is arranged between the active layer and the interface assembly.

According to a further embodiment, the distribution network is arranged within the interface assembly.

According to a further embodiment, the distribution network is arranged under the interface assembly.

According to yet another embodiment, the distribution network is implemented on a primary distribution board arranged within the active layer, and on a secondary distribution board arranged within the interface assembly.

According to yet another embodiment, the primary distribution board comprises electric connectors for connecting the primary distribution board to the secondary distribution board. The secondary distribution board comprises electric connectors passing through the heat exchanger, and configured for connecting to external devices.

According to one embodiment, the interface assembly includes a first frame and a second frame, each frame having corresponding front side and back side. The second frame features a shallow depression on its back side, and the secondary distribution board is disposed substantially inside the shallow depression of the second frame.

According to yet another embodiment, the secondary distribution board is disposed under the second frame.

According to one embodiment, the passive layer is interconnected directly to the radiating layer by a first set of RF connectors.

According to another embodiment, the passive layer is interconnected directly to the active layer by a second set of RF connectors.

According to yet another embodiment, electrical communication between the radiating layer, the passive layer and the active layer include only RF signals.

According to another broad aspect of the present invention, there is provided a vertically stacked array antenna structure including a radiating layer, comprising an array of radiating elements, and a passive layer disposed under the radiating layer and having only passive components. At least a part of the passive components includes an array of RF duplexers, corresponding to the array of radiating elements.

The vertically stacked array antenna structure also includes an active layer disposed under the passive layer and comprising an array of T/R modules. The vertically stacked array antenna structure further includes an interface assembly, comprising at least one metallic frame sandwiched between the active layer and the passive layer. The metallic frame has a compartment structure comprising at least one compartment, and each compartment is defining a cavity. The T/R modules are located substantially inside the cavities defined by the compartments, and are being in direct thermal coupling with the metallic frame. The interface assembly is further configured to provide thermal communication between the active layer and a heat exchanger.

According to yet another broad aspect of the present invention, there is provided a vertically stacked array antenna structure including a radiating layer, comprising an array of radiating elements, and a passive layer disposed under the radiating layer and having only passive components. At least a part of the passive components includes an array of RF circulators, corresponding to the array of radiating elements. The radiating layer is interconnected directly to the passive layer by a first set of RF connectors.

The vertically stacked array antenna structure also includes an active layer disposed under the passive layer and comprising an array of T/R modules. The passive layer is interconnected directly to the active layer by a second set of RF connectors. Further, electrical communication between the radiating layer, the passive layer and the active layer includes only RF signals.

The vertically stacked array antenna structure further includes two metallic frames encompassing therebetween the active layer. At least one of the metallic frames has a compartment structure comprising at least one compartment, and each compartment is defining a cavity. The T/R modules are located substantially inside the cavities defined by the compartments, and are being in direct thermal coupling with at least one of the metallic frames. The metallic frames are further configured to provide thermal communication between the active layer and a heat exchanger.

In the present disclosure, the term “active layer” refers to an electronic assembly comprising at least one active component.

In this disclosure the term “active component” refers to an RF amplifier that amplifies RF signals and requires a DC voltage supply for its operation. Thus, RF transmission and RF reception amplifiers, as well as all other RF amplifiers that operate with RF signals, are considered herein as active components. Consequently, low-frequency amplifiers, analog and digital components, switches, including electrically controlled switches, circulators, resistors, attenuators, connectors, and other devices that are not RF amplifiers, are considered herein as “passive components”.

Furthermore, the term an “active device” refers to a device that comprises active components.

Accordingly, the term “passive layer” herein refers to an electronic assembly that includes one or more “passive components”.

Moreover, the term “channel” herein refers to the entire electronic medium, including a sequence of electric components and lines through which a certain electronic signal passes. Thus, a channel associated with a particular transmission RF amplifier is referred to as a transmission channel, whereas a channel which is associated with a reception RF amplifier is referred to as a reception channel. Accordingly, a channel associated with a particular radiating element and duplexer, including the corresponding pair of reception and transmission channels, is referred to as a T/R channel.

According to another general aspect of the present invention, there is provided a method for production of the vertically stacked array antenna structure described. The method includes providing a radiating layer comprising an array of radiating elements and providing a passive layer having only passive components. At least a part of the passive components includes an array of RF duplexers that correspond to the array of radiating elements.

The method further includes disposing the passive layer under the radiating layer.

The method also includes providing an active layer comprising RF amplifiers, and disposing the active layer under the passive layer.

The method also includes providing an interface assembly comprising at least one metallic frame, and establishing direct thermal coupling of the metallic frame with the RF amplifiers. According to one embodiment, establishing direct thermal coupling between two elements can be performed by bringing the two elements into direct physical contact with one another; or by bringing the two elements into indirect physical contact wherein heat transfer between the two elements is assisted by a third heat conducting element, such as a heat conducting glue or paste, or a heat conducting pad, and provided that introducing such heat conducting element enhances and improves the heat conduction, compared to the unassisted direct physical contact between the two elements. Generally, establishing direct thermal coupling constitutes coupling along a substantial surface area of at least the element which acts as the heat source, thus providing an effective heat transfer from the element being the heat source to the other element.

The method further includes configuring the interface assembly for providing thermal communication of the active layer with a heat exchanger. According to one embodiment, the configuring of the interface assembly for providing heat communication between the active layer and the heat exchanger can be performed by providing thermal interfacing allowing for heat transfer between the active layer and the heat exchanger across the interface assembly, where such heat transfer is carried out by at least one of the known heat transfer mechanisms (e.g. conduction, convection, radiation etc.).

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

### BRIEF DESCRIPTION OF THE DRAWINGS

In order to understand the invention and to see how it may be carried out in practice, embodiments will now be described, by way of non-limiting example only, with reference to the accompanying drawings. Like reference numbers refer to like components throughout the drawings.

FIGS. 1A to 1E are schematic views of a vertically stacked array antenna structure, according to various embodiments of the present invention;

FIG. 2 is a schematic view of a vertically stacked array antenna structure, according to a further embodiment of the present invention;

FIG. 3A is a perspective front view of a vertically stacked array antenna structure in assembled form, according to one embodiment of the present invention;

FIG. 3B is the back side of the interface assembly of the array antenna structure shown in FIG. 3A, according to one embodiment of the present invention;

FIGS. 4A and 4B are exploded perspective views of a vertically stacked array antenna structure, from the front side and back side, respectively, according to one embodiment of the present invention;

FIGS. 5A and 5B are perspective views of a front side and the back side, respectively, of a radiating elements board, according to one embodiment of the present invention;

FIGS. 6A and 6B are perspective views of a front side and a back side, respectively, of an antenna frame, according to one embodiment of the present invention;

FIGS. 7A and 7B are detailed views of the front side and back side, respectively, of a duplexers board, according to one embodiment of the present invention;

FIGS. 8A and 8B show perspective front and back views of a quad T/R module, respectively, according to one embodiment of the present invention;

FIGS. 9A and 9B are perspective views of a front side and a back side, respectively, of a distribution plate, according to one embodiment of the present invention;

FIG. 9C is a perspective view of an active layer, according to one embodiment of the present invention;

FIGS. 10A and 10B are perspective views of a front side and a back side, respectively, of a first frame, according to one embodiment of the present invention;

FIGS. 11A and 11B are views of the front side and back side, respectively, of a second frame, according to one embodiment of the present invention;

FIGS. 12A and 12B are perspective views of a front side and a back side of a secondary distribution board, according to one embodiment of the present invention;

FIG. 13 is a cross-sectional view of a vertically stacked array antenna structure according to one embodiment of the present invention;

FIGS. 14A and 14B are cross-sectional views of board-to-board bullets connectors between a duplexers board and a radiating elements board, according to one embodiment of the present invention;

FIG. 15 is a detailed view of a Teflon RF connector between a Quad T/R module and a duplexers board, according to one embodiment of the present invention; and

FIG. 16 is a detailed view of a fuzz button, according to one embodiment of the present invention.

### DETAILED DESCRIPTION OF EMBODIMENTS

The principles and operation of a vertically stacked array antenna according to the present invention may be better understood with reference to the drawings and the accompanying description. It should be understood that these drawings are given for illustrative purposes only and are not meant to be limiting. It should be noted that the figures illustrating various examples of the system of the present invention are not to scale, and are not in proportion, for purposes of clarity. It should be noted that the blocks as well other elements in these figures are intended as functional entities only, such that the functional relationships between the entities are shown, rather than any physical connections and/or physical relationships. The same reference numerals and alphabetic characters will be utilized for identifying those components which are common in the device and its components shown in the drawings throughout the present description of the invention.

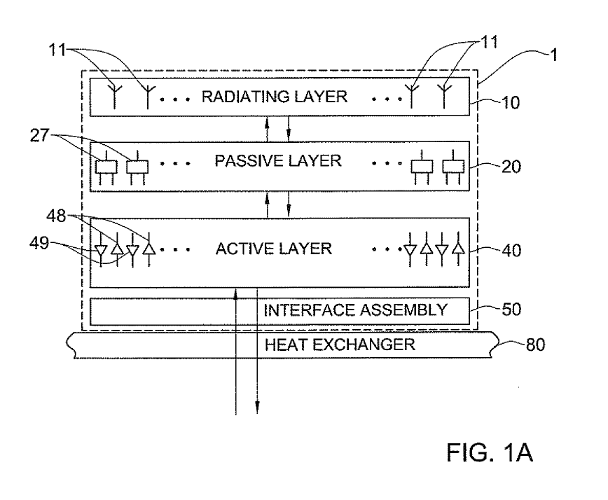

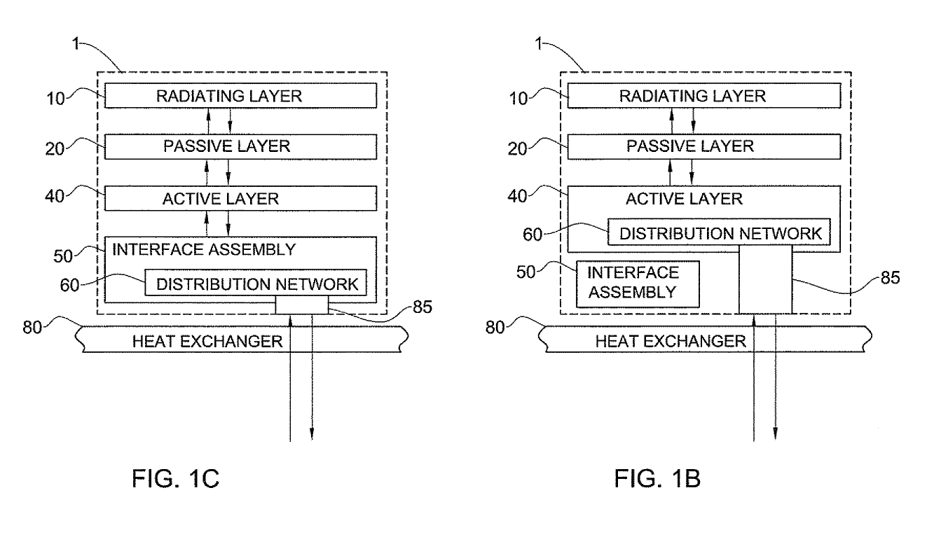

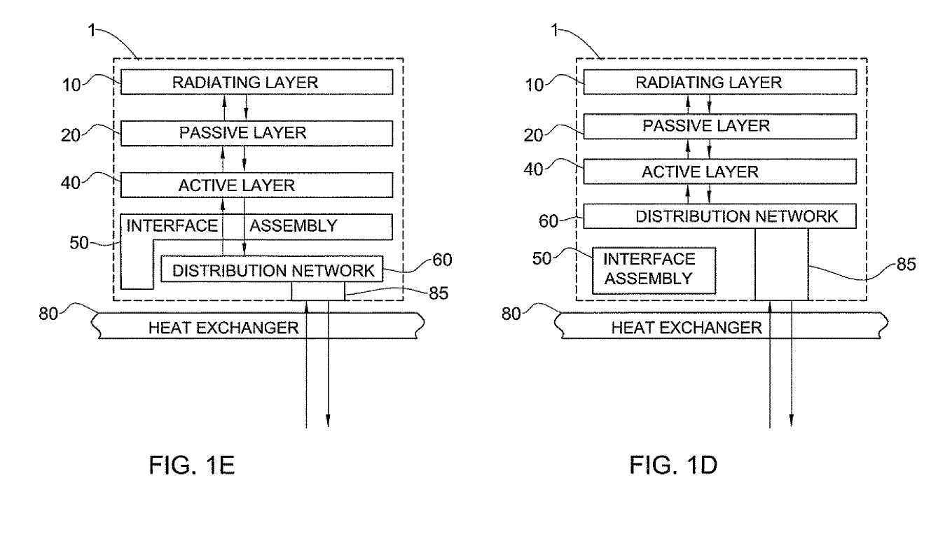

Referring to FIG. 1A, a schematic illustration of a vertically stacked array antenna structure 1 is illustrated, according to one embodiment of the present invention. The term “vertically stacked” is used herein for the purpose of description of a relationship between the layers of the antenna, rather than for description of orientation of the antenna structure in space.

As shown in FIG. 1A, the vertically stacked array antenna structure 1 includes a radiating layer 10, a passive layer 20 disposed under the radiating layer 10, an active layer 40 disposed under the passive layer 20, and an interface assembly 50. According to one embodiment, the radiating layer 10 includes an array of radiating elements 11. Each radiating element 11 can radiate into space radio-frequency (RF) electro-magnetic energy (in short, RF energy) that is fed into the radiating element 11 from the passive layer 20, and may receive RF energy from space and feed this energy on into the passive layer 20.

It should be noted that the subject of this invention is not limited to any to particular implementation of the radiating elements 11. Hence, the radiating elements may be implemented in various alternatives. Examples of the radiating elements 11 include, but are not limited to, patch antenna elements; stacked patch antenna elements, microstrip antenna elements, dipole antenna elements, horn antenna elements, tapered-Slot Antenna (TSA) element (also known as Vivaldi) and other antenna elements or a combination thereof. Consequently, the type, shape and configuration of the antenna elements 11 may be selected to be suitable for the technology adopted for the antenna.

The passive layer 20 has only passive components. At least a part of the passive components includes an array of RF duplexers 27 corresponding to the array of radiating elements 11.

The active layer 40 includes active components, such as a plurality of transmission RF amplifiers 48 configured for amplifying RF signals and supplying power required for transmission of RF energy, and a plurality of reception RF amplifiers 49 configured for amplifying received signals. The interface assembly 50 is thermally coupled directly with the RF amplifiers 48 and 49 in the active layer 40 and is configured for providing thermal communication of the active layer 40 with a heat exchanger 80.

According to one embodiment, each duplexer corresponds to one corresponding radiating element. For example, each duplexer 27 can be coupled to one radiating element 11 in the radiating layer 10, and to one transmission RF amplifier 48 and to one reception RF amplifier 49, in the active layer 40. The RF duplexers 27 are configured for routing the received and transmitted signals. Specifically, in operation, the duplexer 27 receives RF energy from one transmission RF amplifier 48 and forwards this RF energy to the corresponding radiating element 11. Likewise, the duplexer 27 can receive RF energy from the same radiating element and forward it to the corresponding reception RF amplifier 49.

According to one embodiment, the duplexer 27 is implemented as an electronic component which does not require any voltage supply, for example a circulator. Alternatively, the duplexer 27 can be implemented as an electronic component that requires electric power and/or control, for example an RF switch.

It should be understood that the active layer 40 may generate heat, as a result of the operation of the RF amplifiers 48 and 49. In order to remove heat from the active layer 40, the array antenna structure 1 can be thermally coupled to a heat exchanger 80. Thus, the vertically stacked array antenna structure 1 includes the interface assembly 50 proximate to and thermally coupled directly with the RF amplifiers 48 and 49 in the active layer 40. The interface assembly 50 is configured for providing thermal communication between the active layer 40 and the heat exchanger 80. The specific implementations of the interface assembly 50 are described hereinbelow in detail.

When desired, the interface assembly 50 may also include one or more electric circuits (not shown) and electric connectors (not shown) configured to establish electric connection of the antenna to external devices (not shown). Various examples of the electric circuits (not shown) and electric connectors are shown hereinbelow.

Referring to FIGS. 1B through 1E together, schematic views of a vertically stacked array antenna structure 1 are illustrated, according to other embodiments of the present invention. According to these embodiments, the stacked array antenna structure 1 further includes a distribution network 60 including electric connectors 85 configured to establish electric connection between the antenna structure 1 and external devices (not shown). The distribution network 60 is configured for distribution of various electric signals. Examples of the signals handled by the distribution network 60 include, but are not limited to, DC supply signal, control signals, transmission RF signals, Reception RF signals and other signals. Various arrangements of the distribution network 60 are contemplated.

According to the embodiment shown in FIG. 1B, the distribution network 60 is arranged within the active layer 40.

According to the embodiment shown in FIG. 1C, the distribution network 60 is arranged within the interface assembly 50.

According to the embodiment shown in FIG. 1D, the distribution network 60 is arranged between the active layer 40 and the interface assembly 50.

According to the embodiment shown in FIG. 1E, the distribution network 60 is arranged under the interface assembly 50.

Specific implementations of the distribution network 60 are shown hereinbelow.

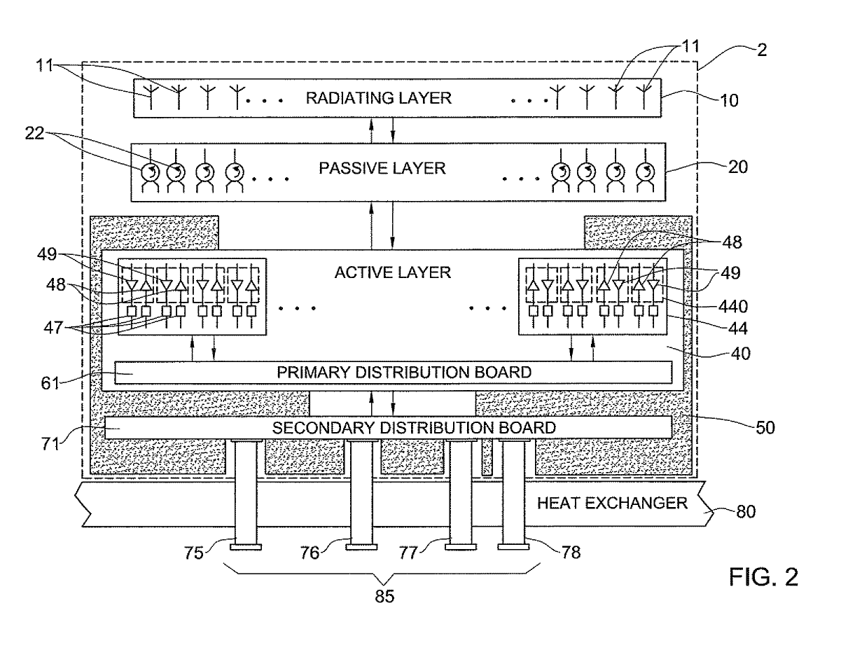

FIG. 2, to which reference is now made, illustrates a vertically stacked array antenna structure 2, according to a further embodiment of the present invention. As shown in FIG. 2, the vertically stacked array antenna structure 2 includes the radiating layer 10, including the radiating elements 11. The antenna structure 2 also includes the passive layer 20 disposed under the radiating layer 10. According to the embodiment shown in FIG. 2, the passive layer includes an array of circulators 22.

Furthermore, the antenna structure 2 includes the active layer 40 disposed under the passive layer 20, and the interface assembly 50, thermally coupled directly with the RF amplifiers 48 and 49 in the active layer 40 and configured to provide thermal communication of the active layer 40 with the heat exchanger 80.

The RF circulators 22 are configured for routing transmission signals from the plurality of the transmission amplifiers 48 arranged in the active layer 40 to the radiating elements 11. Likewise, the RF circulators 22 are configured for routing received signals from the radiating elements 11 to the plurality of the reception amplifiers 49 arranged in the active layer 40. For electrical communication between the passive layer 20 and the active layer 40 the vertically stacked array antenna structure 2 can include one or more transmission and reception RF connectors (not shown). It should be understood that since the circulators 22 do not require any control bias or control signals for operating, the connection between the passive layer 20 and the active layer 40 might not require any other connections in addition to the transmission and reception RF connections. In other words, the electronic communication between the active layer 40, the passive layer 20, and the radiating layer 10, can be carried out only by RF signals.

When desired, the RF amplifiers 48 and 49 may be implemented using MMIC-based integrated technology. According to one embodiment of the present invention, the plurality of RF amplifiers 48 and 49 are integrated into RF amplifier modules. In this case, each RF amplifier module can include at least two RF amplifiers. For example, each RF amplifier module can include at least one transmission RF amplifier 48 and at least one corresponding reception RF amplifier 49.

According to another embodiment, the transmission amplifiers 48 and the reception amplifiers 49 can be arranged in Quad T/R modules 44. In other words, one or more RF amplifier modules can include four pairs 440 of RF amplifiers 48 and 49. Specifically, each pair 440 of the RF amplifiers 48 and 49 can include one transmission RF amplifier 48 and one reception RF amplifier 49 and can correspond to one corresponding circulator 22. Each T/R quad module 44 provides four T/R channels. Thus, each such channel has one transmission channel and one corresponding reception channel. Accordingly, each quad T/R module 44 can be coupled to four corresponding circulators in the passive layer 20, which in turn can be further coupled to four corresponding radiating elements 11.

According to an embodiment, RF signals passing through the transmission and reception channels are amplified in a controlled manner by the appropriate RF amplifiers 48 and 49. The RF amplifiers 48 in the transmission channel can form the last amplification stage in the channel, essentially providing the required power to the transmitted signal. Likewise, the RF amplifiers 49 in the reception channel can form the first amplification stage in the reception channel, thus affecting the strength of the received signal and the signal-to-noise ratio in the entire system that employs the array antenna structure 2.

It should be understood that the structure described above can provide a direct and short path between the active layer 40 (including the T/R modules 44) and the radiating layer 10 (including the radiating elements 11), through the passive layer 20 (including the circulators). This provision may reduce losses of signal power in both transmission and reception directions, and also enhance reliability of the antenna structure performance.

According to a further embodiment of the present invention, one or more RF amplifier modules 44 include at least one phase shifter 47. Specifically, as shown in FIG. 2, the phase shifters 47 can be incorporated within the quad T/R modules 44. According to one embodiment, the phase shifters 47 can be associated with each T/R channel (not shown). For example, one individual phase shifter 47 can be associated with one transmission channel or one reception channel. Alternatively, one phase shifter 47 can be associated with a single T/R channel (i.e., with a pair having a transmission and corresponding reception channel).

In operation, the phase shifters 47 are controlled by predetermined control signals. Thus, the phase shifters 47 provide controlled phase shifts to RF signals passing therethrough. Accordingly, a selective tuning of the phase shift in each transmission and/or reception channel, may determine the resulting cumulative shape and direction of the beam emanated from the antenna (or received by the antenna, respectively).

Although a description for the incorporation of four T/R channels in a single quad module is provided above in detail, generally, any level of integration of T/R channels in a single module is also contemplated. For example, a module may include one or more pairs of transmission and reception channels. Likewise, integration of RF amplifiers into modules may be based on different approaches. For example, some of the modules can include only RF transmission amplifiers, whereas other modules can include RF reception amplifiers. Furthermore, any such integrated modules may include phase shifters. Alternatively, phase shifters may be packaged in different modules.

It should be understood that active layer 40 that includes RF amplifiers 48 and 49 is a major heat source in the array antenna structure 2. Thus, as indicated above, the antenna structure 2 includes the interface assembly 50 arranged proximate to and in direct thermal coupling with the T/R modules, thereby providing direct thermal coupling to the RF amplifiers 48 and 49 in the active layer 40. The interface assembly 50 is therefore configured for providing thermal communication between the active layer 40 and the heat exchanger 80, which may disperse or carry the heat away from the array antenna structure 2.

According to a further embodiment of the present invention, the antenna array structure 2 includes the distribution network 60 that is implemented on a primary distribution board 61 and a on a secondary distribution board 71. The primary distribution board 61 and the secondary distribution board 71 can be coupled to each other by fuzz buttons (not shown).

It should be noted that the choice of employing one or more distribution boards as well as the allocation of the functions of the distribution network 60 to the primary distribution board 61 and the secondary distribution board 71 can depend on many factors, e.g., the size of the array in terms of the number of the radiating elements 11, the density of components on the boards, the configuration of the RF amplifier modules associated with T/R channels, etc.

For example, the primary distribution board 61 can provide a primary distribution of RF, logic and DC (voltage supply) signals and be arranged within the active layer 40. In turn, the secondary distribution board 71 can perform the remaining distribution functions and be arranged within the interface assembly 50.

According to one embodiment, the secondary distribution board 71 can include a set 85 of electric connectors that pass through the heat exchanger 80, and are configured for connecting the array antenna structure 2 to external devices (not shown).

For example, the set 85 of electric connectors can include four connectors 75, 76, 77 and 78, related to RF reception signals, RF transmission signals, control signals, and to DC input signals, correspondingly. It should be noted that the existence of a relatively small number of the connectors in the antenna structure described above may facilitate assembly or disassembly of the antenna structure 2 and connection of the antenna structure to or from a transceiver device (not shown). In particular, such a provision may reduce the time required for assembly or disassembly, and therefore may reduce cost associated with maintenance of the antenna. Furthermore, it may increase reliability of the antenna structure.

It should be understood that although four electric connectors 75, 76, 77, and 78 dedicated for connection with external devices are presented in the example shown in FIG. 2, the connection of the antenna structure to external devices can be carried out by any suitable number of connectors.

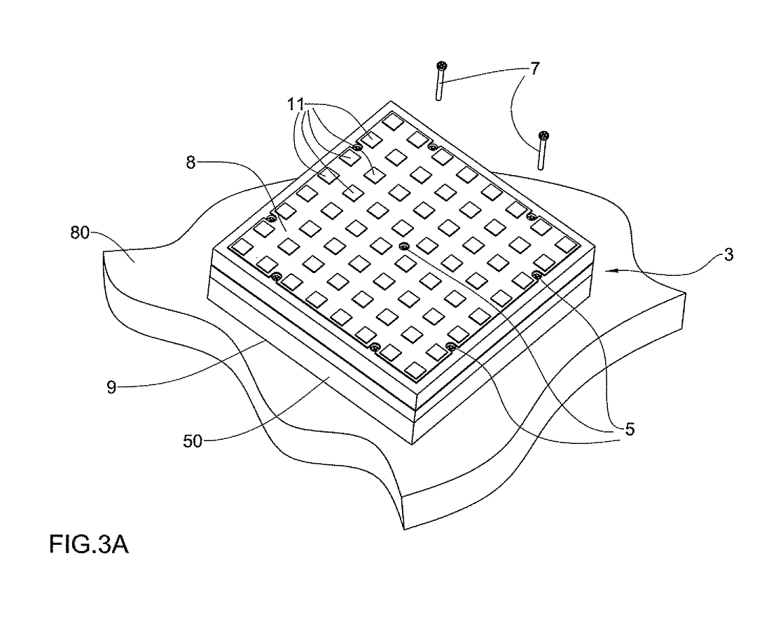

Referring to FIG. 3A, a perspective front view of a vertically stacked array antenna structure 3 in assembled form is illustrated, according to one embodiment of the present invention. A front side 8 of the array antenna structure includes the array of radiating elements 11. In the example shown in FIG. 3A, the radiating elements are arranged in 8 columns and 8 rows (herein referred to as an 8×8 array), however, other arrangements are contemplated.

It should also be noted that although the array antenna shown in FIG. 3A has a square shape, it may alternatively take other shapes, including, but not limited to, a circular, oval, polygonal (e.g., triangular, rectangular, quadrilateral, pentagon, hexagonal, etc) and other shapes. Accordingly, a number of the rows in which the radiating elements 11 are arranged can be equal to the number of the columns. Alternatively, the numbers of the rows and the columns in the antenna array can be different. Moreover, a number of the radiating elements 11 in neighboring rows can be either equal or different. Moreover, the arrangement of the radiating elements 11 in the array can be either regular or staggered.

It should still further be noted that the array antenna 3 may be used as a single radiator in conjunction with a transceiver device, or it may be combined together with additional antenna arrays to form a larger array antenna. And it should still further be noted that although the front side 8 of the array antenna shown in FIG. 3A has a planar shape, when desired, the array antenna may alternatively have a curved or undulated face.

As shown in FIG. 3A, the array antenna structure 3 is mounted on a heat exchanger 80, so that the interface assembly 50 that is arranged at a back side 9 would be in thermal communication with the heat exchanger 80. The heat exchanger 80 can be used as a heat sink for cooling the array antenna structure 3. In operation, the heat generated inside the array antenna structure 3 by various electronic components, may be transferred to the heat exchanger 80 through the interface assembly 50, thus maintaining the temperature of the array antenna structure and its components within a desired temperature range.

It should be noted that the heat exchanger 80 can be implemented in various ways. For example, the heat exchanger 80 may be structured as a heat conducting plate having cooling protrusions or lamination for increase of the rate of heat dissipation to the surroundings. Further, heat may be carried away from the plate into ambient surroundings with the help of a fan or other blowing device that can blow air onto the heat sink. Alternatively, the heat exchanger 80 can include canals in which a coolant fluid (e.g., gas or a liquid) is forced by a cooling circulation system.

In the embodiment shown in FIG. 3A, the array antenna structure 3 is connected to the heat exchanger 80 by screws 7 that connect the structure 3 to the heat exchanger 80 via holes 5. It should be noted that various alternative types of connections may be utilized for connection of the structure 3 to the heat exchanger 80. For example, screws can be used to connect the array to the heat exchanger in the opposite direction, namely inserted from the heat exchanger side and screwed into appropriate threads in the array antenna structure 3. Moreover, screws can be screwed into screw-nuts arranged on the front side of the array, or thereinside. Alternatively, the whole array may be connected onto the heat-exchanger by snap-on clips, or it could be welded, brazed, soldered or glued onto the heat exchanger 80. Further, any other known type of connection or attachment of the array to the heat exchanger may be adopted so as to provide and maintain mechanical support and thermal communication between the array and the heat sink.

Referring to FIG. 3B, the back side of the interface assembly 50 of the array antenna structure 3 is shown, according to one embodiment of the present invention. Connectors 85 on the back side 9 of the interface assembly 50 are configured to establish the required electrical connections of the antenna structure 3 with external devices (not shown). The connectors 85 are further configured to pass through the heat exchanger 80, via designated holes 86. It should be noted that the limited number of electronic connectors to and from the antenna array structure 3 and the simple mechanical connection of the structure 3 to the heat exchanger 80 allow the antenna array structure 3 to be easily mounted or dismounted, and thereby simplifies its maintenance and/or any technical access thereto.

It should be understood that although the array antenna structure 3 is described herein above as a dedicated separated element, when desired the heat exchanger 80 can be a part of the structure 3. In other words, the array antenna structure 3 can include the heat exchanger 80 mounted under and thermally communicating with the interface assembly 50.

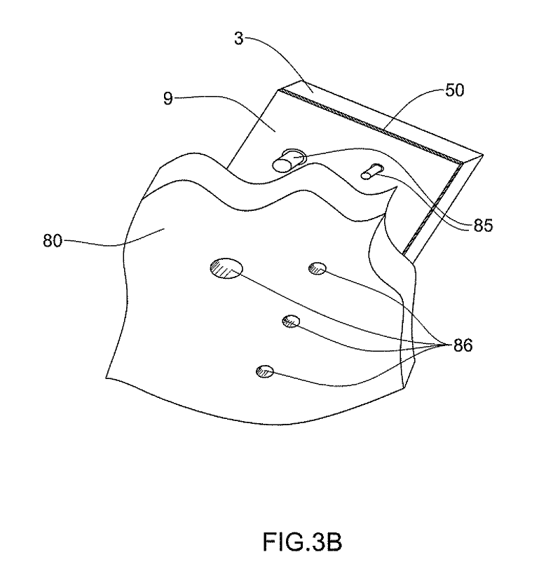

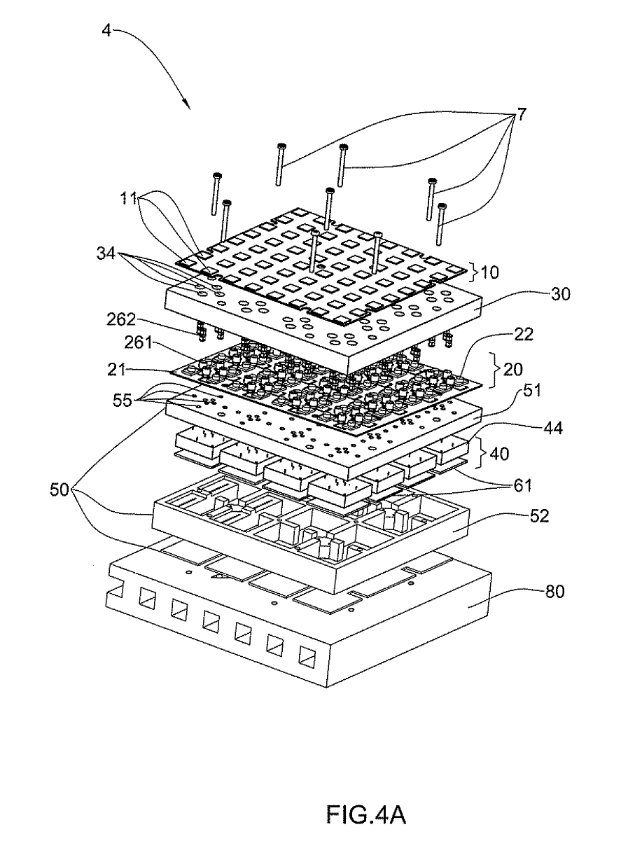

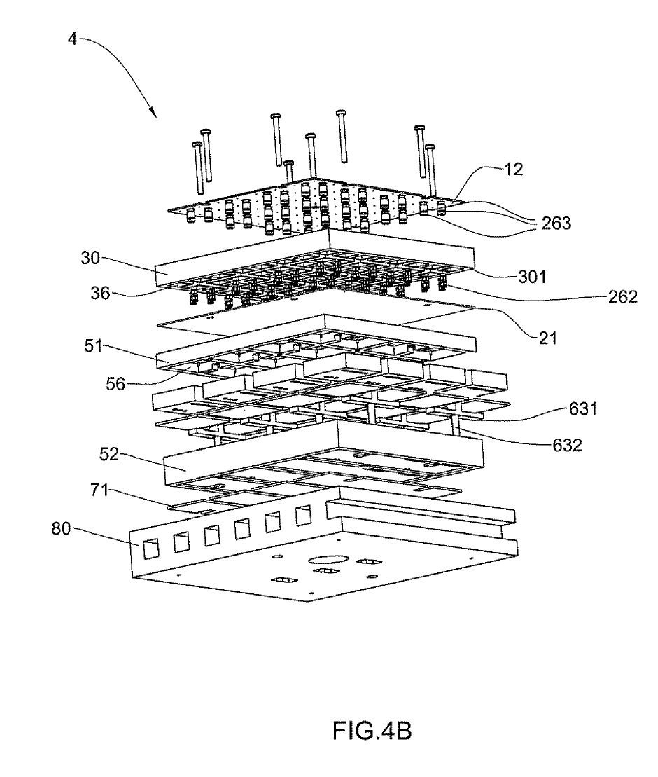

Reference is now made to FIG. 4A and FIG. 4B together, in which exploded perspective views of a vertically stacked array antenna structure 4 are shown, from the front side and from the back side, respectively, according to one embodiment of the present invention.

The radiating layer 10 of the antenna structure 4 includes a radiating elements board 12 on which the array of radiating elements 11 in the form of patch antenna elements is printed. The radiating elements board 12 can, for example, be a printed circuit board (PCB).

The antenna structure 4 also includes an antenna frame 30 disposed under the radiating layer 10. The radiating elements board 12 is attached to the antenna frame 30 in order to receive mechanical support. A back side 301 of the antenna frame 30 has a compartment structure having compartments 36 defining cavities for encompassing the circulators 22 therein. Accordingly, the passive layer 20 of the antenna structure 4 includes a duplexers board 21, on which the array of circulators 22 is mounted. When the antenna structure 4 is assembled, each circulator 22 fits into the corresponding compartment 36 in the antenna frame 30. An RF connection between each of the circulators 22 to a corresponding one of the radiating elements 11 is implemented by RF connectors 26 which pass through holes 34 arranged in the antenna frame 30. It should be noted that disposing the duplexers board 21 under the radiating elements board 12, provides a short distance between the circulators 22 and the radiating elements 11, and thus enables a low-loss RF interconnections between the circulators 22 and the radiating elements 11.

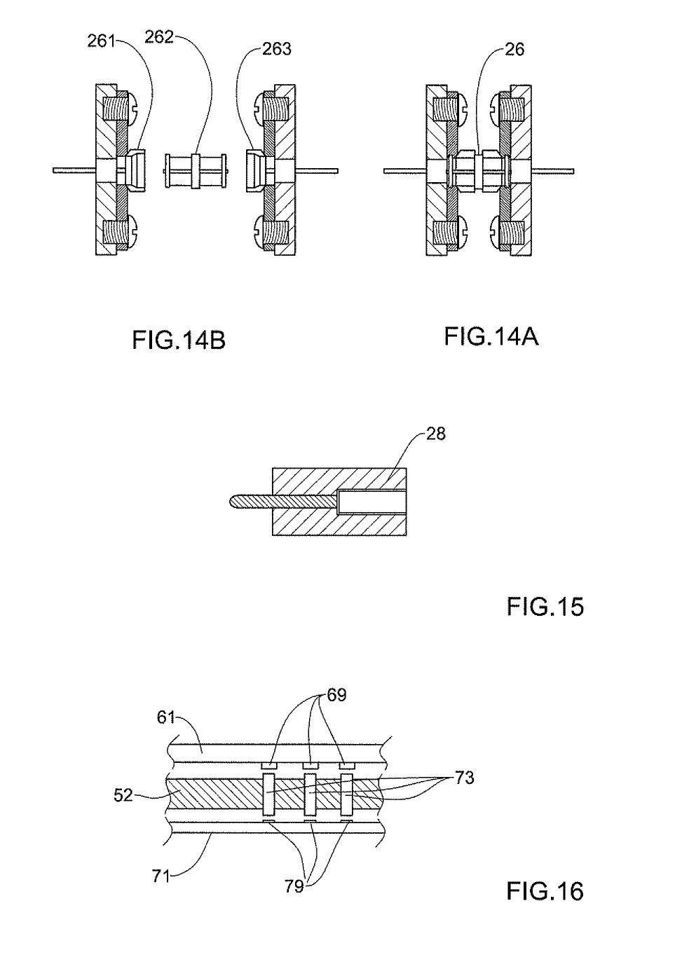

An example of the RF connector 26 in the form of a board-to-board bullet in its assembled form is shown in FIG. 14A. An example of the board-to-board bullet in an exploded view is shown in FIG. 14B. The board-to-board bullet has two panel mounted parts 261 and 263, and a bullet part 262. The panel mounted parts 261 and 263 of the board-to-board bullet connector are mounted on the duplexers board (21 in FIGS. 4A and 4B) and on the radiating elements board (12 in FIGS. 4A and 4B), respectively, in corresponding locations. The intermediate bullet part 262 interconnects the parts 261 and 263 by being inserted into them, when the two boards are assembled together. The board-to-board bullet connectors may potentially compensate some mechanical tolerances that might appear in the assembly of the boards, particularly due to the multitude of these interconnects. It may thus provide low-loss and reliable RF connection between the two boards, combined with fast assembly—namely fast interconnection of the boards to one another. It should be noted that other off-the-shelf or custom-made connectors can be used for the purpose of RF connections between the duplexers board 21 and the radiating elements board 12.

It should further be noted that an interconnection scheme comprising RF connectors between the passive layer 20 and the radiating layer 10, as described above, allows for employing a variety of antenna elements with the invented array antenna structure. Thus, for example, the use of such RF connectors allows the employment of e.g. “Vivaldi” type or dipole type antenna elements, while these antenna element types might be impossible or very difficult to employ when combined with an interconnection scheme based on soldering and RF transmission lines rather than RF connectors.

Turning back to FIGS. 4A and 4B, the active layer 40 includes a plurality of the quad T/R modules 44, and the primary distribution boards 61. According to the shown embodiment, each quad T/R module 44 is associated with four T/R channels. Each T/R channel includes one transmission channel and one reception channel. The interconnection between the quad T/R module 44 and the RF circulator 22 is implemented by using RF connectors 28. The connectors 28 pass through holes 55 in the interface assembly 50, as is further described in detail hereinbelow. An example of the RF connectors 28 include, but is not limited to Teflon connectors shown in detail in FIG. 15.

It should be noted that an interconnect scheme employing such a first set of RF connectors (e.g. RF connectors 26) between the passive layer 20 and the radiating layer 10, and a second set of RF connectors (e.g RF connectors 28) between the active layer 40 and the passive layer 20, allows quick and simple disassembly of the antenna structure 4 into its layers, and consequently allows cheap maintenance of the antenna, by providing easy and fast access to the active components, namely the RF amplifiers and/or the T/R modules.

According to the embodiment shown in FIGS. 4A and 4B, the interface assembly 50 of the antenna structure 4 includes a first frame 51 and a second frame 52, both frames disposed under the passive layer 20. The interface assembly 50 also includes the secondary distribution board 71 disposed under the second frame 52. The first frame 51 and the second frame 52 are rigid frames that support mechanically the active layer 40 surrounded by the first frame 51 and the second frame 52. Specifically, brackets 631 and screws 632 press the primary distribution boards 61 and the quad T/R modules 44 onto the first frame 51.

As described above, the T/R modules 44 of the active layer 40 is the major heat generation source in the antenna array structure 4. The first frame 51 and the second frame 52 which are thermally coupled directly with the T/R modules 44 (and thereby with the RF amplifiers thereinside) act as heat conductors carrying heat from the active components (RF amplifiers) of the active layer 40 towards the heat exchanger 80. When assembled, the first frame 51 and the second frame 52 are thermally coupled to each other. To provide thermal conductivity, the first frame 51 and the second frame 52 can, for example, be made from metal, however other thermo-conductive materials are also contemplated. It should be noted that the use of metal is preferable because metal usually provides both good heat conduction as well as radiation shielding, and because metal is not fragile, thus lending itself easily to be fit to the array antenna structure which typically requires relatively large frames.

According to one embodiment the circulators 22 are mounted on the back side of the duplexers board 21. Accordingly, the antenna frame 30 is arranged under the duplexers board 21, having the compartments 36 on its front side. According to yet another embodiment, the duplexers 27 are mounted on the back side of the duplexers board 21 as described above, and the first frame 51 has a compartment structure on its front side wherein the circulators 22 are inserted when the antenna structure 4 is assembled.

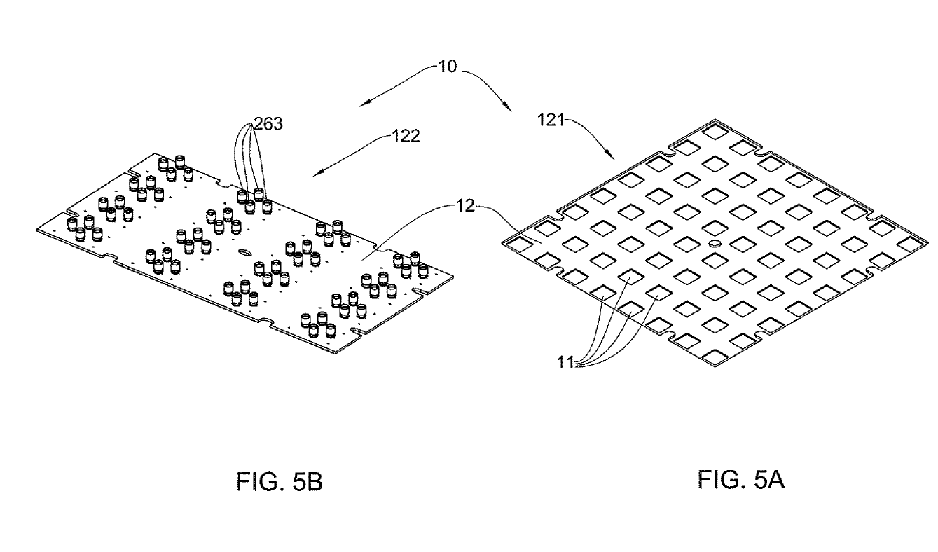

Reference is now made to FIGS. 5A and 5B together, which are perspective views of a front side 121 and a back side 122, respectively, of the radiating elements board 12. The board 12 is made from a material and is configured in a form suitable to carry the radiating elements 11 and the panel mounted parts 263 of the connectors (26 in FIG. 14A). For example, the board 12 can be a printed circuit board (PCB) made of RF-suitable materials, e.g., soft Teflon RT duroid™ 5880 by ROGERS. As shown in FIG. 5A, the radiating elements 11 (in the form of square patch antenna elements) are printed on the front side 121 (i.e., PCB top layer). As shown in FIG. 5B, the panel mounted part 263 of the board-to-board bullet connectors 26 is mounted on the back side of the board (PCB) 12.

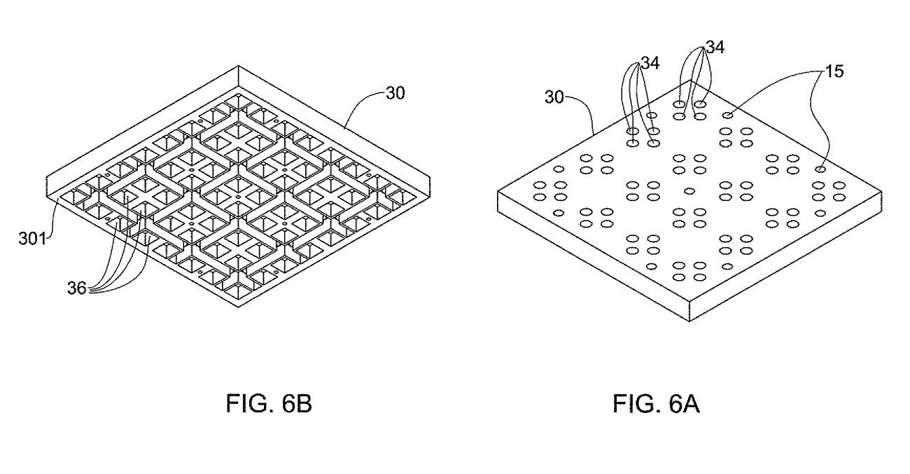

FIGS. 6A and 6B, to which reference is now made, are perspective views of the antenna frame 30 from a front side and a back side, respectively. The antenna frame 30 has holes 34 passing through the antenna frame, through which RF interconnection is made between the duplexers board 21 and the radiating elements board 12, by using RF connectors (26 in FIG. 14A). For example, there is one such through-hole 34 for each radiating element 11 and a corresponding circulator 22. The antenna frame 30 also has through holes 15 through which screws (not shown) can pass, which are used to assemble the array antenna, as is described above.

The antenna frame 30 can be made from a rigid material. Thus, when the array antenna structure (4 shown in FIGS. 4A and 4B) is assembled, the board (i.e., PCB) 12 is pressed onto the antenna frame 30, thus the antenna frame 30 provides the PCB 12 with mechanical support and rigidity.

On the back side 301 of the antenna frame 30, a compartment structure is shown, composed of compartments 36, where each compartment defines a cavity. For example, one compartment can correspond to one circulator 22, so when the array antenna structure 4 is assembled, each circulator 22 can be substantially inserted in the corresponding cavity of the compartment.

According to an embodiment of the present invention, the antenna frame 30 can be made from a rigid, electrically conductive material. For example, the antenna frame 30 can be made from metal. Thus, each compartment 36, which encloses the circulator 22, shields the circulator located therein from radiation originated from the surroundings, particularly, from the radiation of the neighboring circulators 22. Likewise, the antenna frame 30 shields surrounding elements from radiation that might leak from the circulator enclosed therein. It should be understood that an antenna frame made of metal is not fragile and therefore may be adopted easily to the construction of the array antenna structure which typically requires relatively large frames.

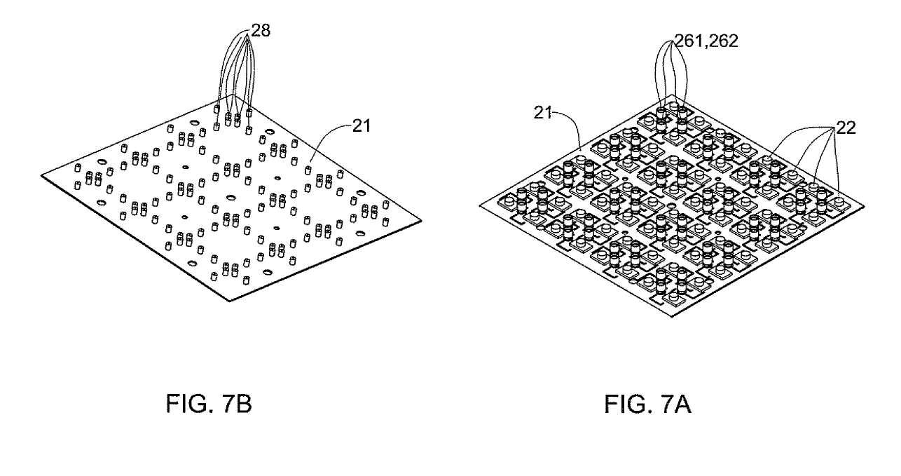

FIG. 7A, to which reference is now made, shows a front side of the duplexers board 21. The duplexers board 21 can, for example, be a printed circuit board (PCB). Moreover, in order to maintain low power losses, the duplexers board 21 can be made from suitable RF suitable material, e.g., soft Teflon.

The circulators 22 mounted on the duplexers board 21, are usually made of ferromagnetic materials. In operation, the circulators 22 function as routers of the RF signal, as described above. The circulators 22 may be chosen to be off-the-shelf items, e.g., RADI-5.85-6.4-MSS-0.5WR-S, which are surface mounted on the PCB. Alternatively, the circulators 22 can be Drop-In devices, or any other suitable custom-made devices. It should also be understood that the circulators 22 may further be implemented in a number of other alternative ways. For example, PCB-integrated circulators described in International Patent Application WO2006/066254, the description of which is incorporated herein by reference, can also be used.

The duplexers board 21 also includes the panel mounted parts 261 of the board-to-board bullet connectors (26 in FIG. 14A) that connect circulators 22 to radiating elements (11 in FIGS. 4A and 4B) mounted on the radiating elements board (12 in FIGS. 4A and 4B).

FIG. 7B shows the back side of the duplexers board 21. The back side of the duplexers board 21 includes connectors 28 (see also FIG. 15). The connectors 28 can, for example, be drop-in Teflon connectors. For example, connector 28 provided by 1st Call Electronics, Inc (item 9099-5449-54 in the AMP Components catalogue) can be suitable for the purpose of the present invention.

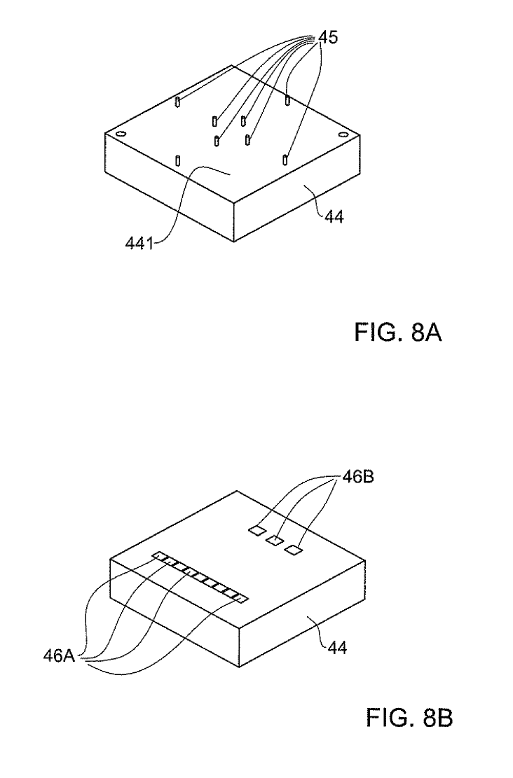

FIGS. 8A and 8B to which reference is now made, show perspective front and back views of a quad T/R module 44, respectively, according to one embodiment of the present invention. According to one embodiment the quad T/R module 44 incorporates MMIC-based integrated RF circuitry of four T/R channels including for example RF amplifiers, phase shifters and supplementary circuitry (not shown).

Accordingly, each T/R module 44 can be equipped with eight pins 45 arranged on its front side 401 in four pairs. When the antenna structure 4 is assembled, the pins 45 fit into the corresponding connectors (28 in FIG. 7B) mounted on the back side of the duplexers board (21 in FIG. 7B).

On the back side of the T/R module 44 (shown in FIG. 8B), there are a number of soldering pads 46. A part of the pads 46 (e.g., the pads indicated by reference numeral 46A) can, for example, be responsible for delivering DC and control signals. The remaining pads (e.g., the pads indicated a reference numeral 46B) can, for example, be responsible for delivering RF signals.

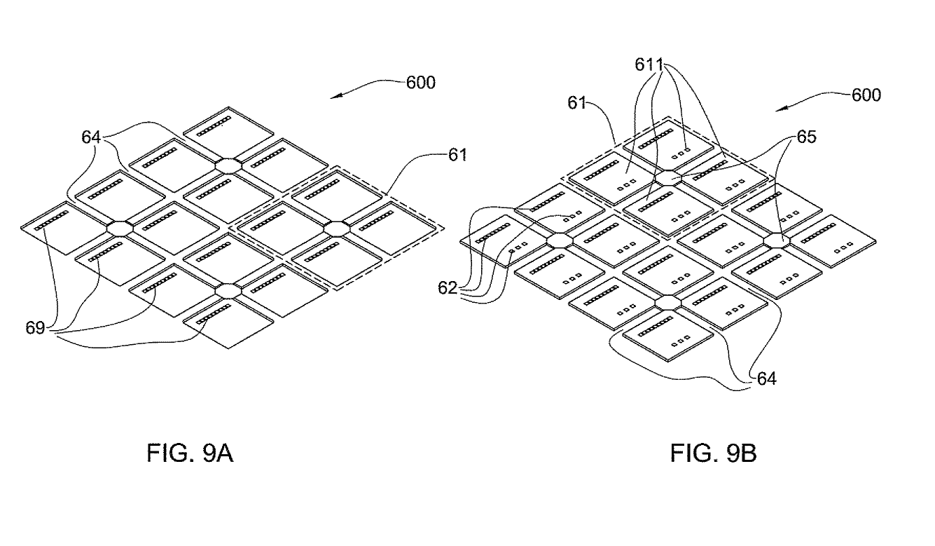

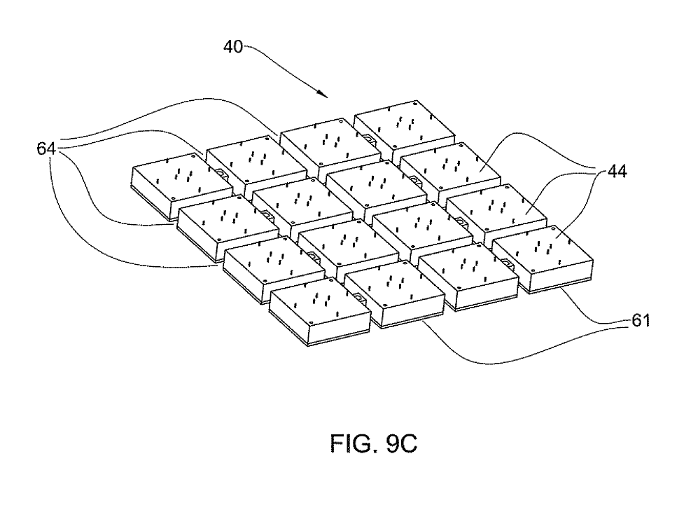

Reference is now made to FIGS. 9A and 9B, showing a front side and a back side of a distribution plate 600, including four primary distribution boards 61, according to one embodiment of the present invention. Each board 61 has four quadrants 611, connected to each other by a flex PCB 65. The distribution plate 600 further features slots 64 between the quadrants 611. For interconnect purpose, each quadrant 611 has an array of pads 62 corresponding to the pads 46A and 46B (shown in FIG. 8B) mounted on the back side of the quad T/R module 44. Hence, interconnection between the boards 61 and the corresponding T/R modules 44 is carried out by soldering of the pads 62 on the boards 61 to the pads 45 on the T/R modules 44.

Referring to FIG. 9B, back side of the distribution plate 600 is shown. Electrical contacts 69 are arranged on the back side of the boards 61. The contacts 69 are employed to form electrical contact between the primary distribution boards 61 and the secondary distribution board (71 in FIGS. 4A and 4B). Such electrical contact can for example, be implemented by using fuzz buttons 73 as is described in detail further below with reference to FIG. 16.

FIG. 9C, to which reference is now made, shows the active layer 40, according to one embodiment of the present invention. The active layer 40 includes the distribution plate 600 including the boards 61 connected to the T/R modules 44. Such connection can for example be implemented by soldering, welding, gluing or any other suitable technique. The slots 64 in the distribution plate 600 correspond to the distances between the quad T/R modules when the boards 61 are connected to the modules 44. The slots 64 thus define gaps through which the first and second frames, 51 and 52 respectively (not shown) are attached, as is described further below.

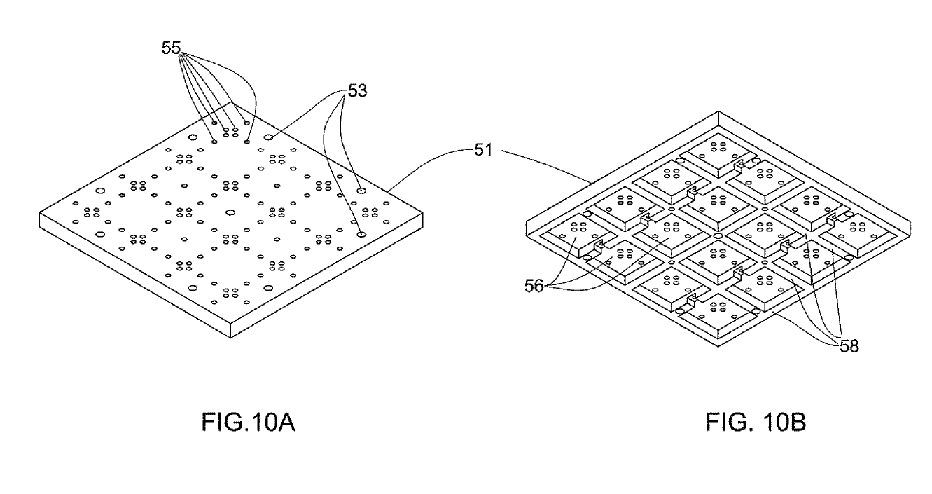

FIG. 10A shows a perspective front view of the first frame 51, according to one embodiment of the present invention. The first frame 51 has through holes 55 through which RF interconnection between the T/R quad modules 44 and the duplexers board 21 (see also FIGS. 4A and 4B) is performed.

According to one embodiment, the first frame 51 is made from a rigid material, thereby providing mechanical support to the active layer 40. Moreover, the first frame 51 can be made from an electrically conductive rigid material. For example, the first frame 51 can be made of metal. The first frame 51 also incorporates through holes 53 configured for inserting mounting screws (not shown), which can, for example, be used for connecting the antenna array structure to the heat exchanger 80.

FIG. 10B shows a perspective back view of the first frame 51, according to one embodiment of the present invention. The back side of the first frame 51 features a compartment structure, including compartments 56. The compartments 56 thus define cavities on the back side of the frame 51. According to one embodiment, each compartment can be associated with one T/R module 44. Thus, when the array antenna structure 4 is assembled, each T/R module 44 is substantially inserted in the corresponding compartment.

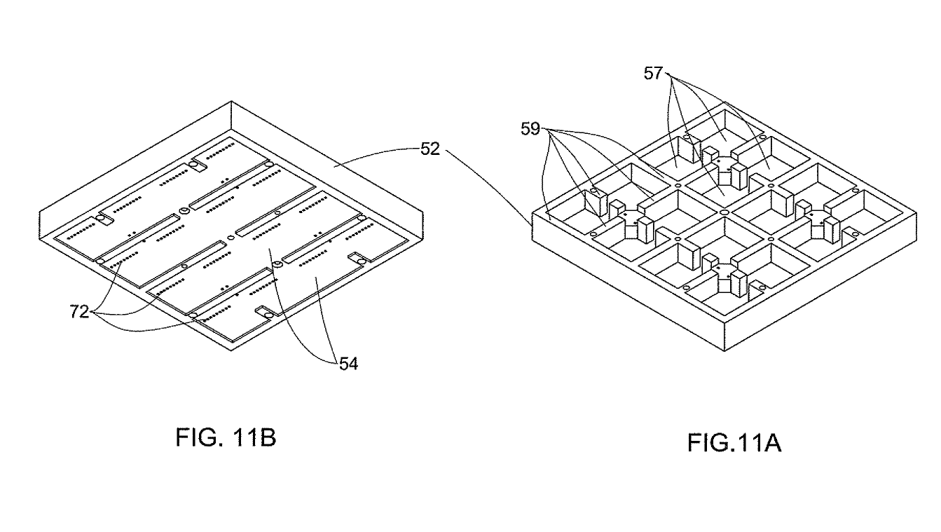

FIG. 11A shows a perspective front view of the second frame 52, according to one embodiment of the present invention. According to one embodiment, the second frame 52 is made from a rigid material, thereby providing mechanical support to the antenna structure 4. Moreover, the second frame 52 can be made of an electrically conductive rigid material. For example, the second frame 52 can be made of metal.

The front side of the second frame 52 features a compartment structure, including compartments 57, thus defining cavities on the front side of the second frame 52. Each compartment 57 can be associated with one T/R module 44. Moreover, the compartments 57 should be in correspondence with the compartments 56 on the back side of the first frame 51. Thus, when the array antenna structure 4 is assembled, the back side of the first frame 51 is attached to the front side of the second frame 52 substantially along surfaces 58 and 59 of the frames 51 and 52, respectively.

The surfaces 58 and 59 are attached through the slots 64 of the distribution plate 600 (shown in FIGS. 9A-9C). As a result, each T/R module 44 is encompassed within the corresponding compartments. In operation, the compartment shield the T/R modules 44 enclosed thereinside from radiation generated in the surroundings, particularly radiation from radiation of the neighboring T/R modules. Furthermore, such compartment can also shield the surrounding elements from the radiation that might leak from the enclosed module 44.

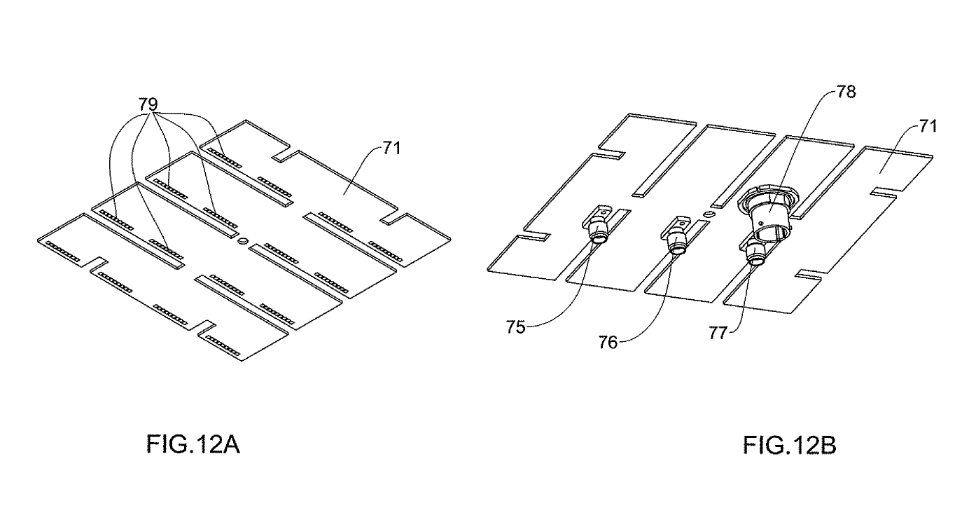

Referring to FIG. 11B, a perspective view of a back side of the second frame 52 is shown, according to one embodiment of the present invention. The back side of the second frame 52 features a shallow depression 54 that fits to the outline of the secondary distribution board (shown in FIGS. 12A and 12B).

The secondary distribution board 71 is shown in FIG. 12A to which reference is now made. When the antenna structure 4 is assembled, the secondary distribution board 71 is disposed under the second frame 52, on the back side of the second frame 52 and located substantially inside the shallow depression 54 thereof. Therefore, when the antenna structure 4 is assembled, the board 71 does not protrude beyond the walls of depression 54 in the frame 52. Thus, attachment of the assembled array antenna 4 to heat exchanger 80 brings the back side of the second frame 52 into direct contact with the heat exchanger 80. As a result, a good thermal connection between the heat exchanger 80 and the second frame 52 is achieved, thereby providing efficient heat removal from the array antenna structure 4 to the heat exchanger 80.

FIG. 12A shows a front side of the secondary distribution board 71, according to one embodiment of the present invention. The secondary distribution board 71 includes contacts 79 corresponding to the contacts 69 mounted on the primary distribution boards 61. The contacts 69 and 79 are configured to provide electrical connections between the secondary distribution board 71 and the primary distribution boards 61.

Referring to FIG. 12A and FIG. 16 together, fuzz buttons 73 are provided for coupling the contacts 69 to the contacts 79. When the array antenna structure 4 is assembled, the boards 61 and 71 are pressed towards one another so that the second frame 52 is sandwiched therebetween. The fuzz buttons 73 are inserted via the through-holes 72 arranged in the second frame 52, and thereby form electrical contact between the corresponding electrical contacts 69 and 79. It should be noted that implementing the fuzz buttons 73 for the electric connection between the primary and secondary distribution boards 61 and 71 respectively, is provided as an example, and this connection may be implemented by other known types of connectors used for PCB interconnection as well.

It should be noted that employing e.g. fuzz buttons between the primary and secondary boards of the distribution network, facilitate quick and simple disassembly of the active layer from the antenna structure. Further, the interconnection scheme based on RF connectors (e.g. the Teflon connectors 28 in FIG. 15) between the active layer 40 and the duplexers board 21, as well as between the duplexers board and the radiating layer 10 (e.g. the board to board bullet connectors 26 in FIG. 14A) as described above, allows easy and therefore cheap maintenance of the antenna. Indeed, the interconnection scheme based on RF connectors allows relatively simple and easy integration and disintegration of the structure, and fast access to the active components, namely the RF amplifiers and/or the T/R modules.

Referring to FIG. 12B, a back side of the secondary distribution board 71 is shown, according to one embodiment of the present invention. The back side of the secondary distribution board 71 includes a set of electric connectors 75, 76, 77 and 78, that can, for example, be related to RF reception signals, RF transmission signals, control signals, and to DC input signals, correspondingly. The connectors 75, 76, 77 and 78 are configured to pass through the heat exchanger (not shown) and to connect to one or more external devices, e.g. to a transceiver device. In the described embodiment, the connectors 75, 76, 77 and 78 provide all the electrical connections which can be required for the proper operation of the array antenna structure. It should however be noted, that generally, the array antenna structure can be provided with any desired number of connectors.

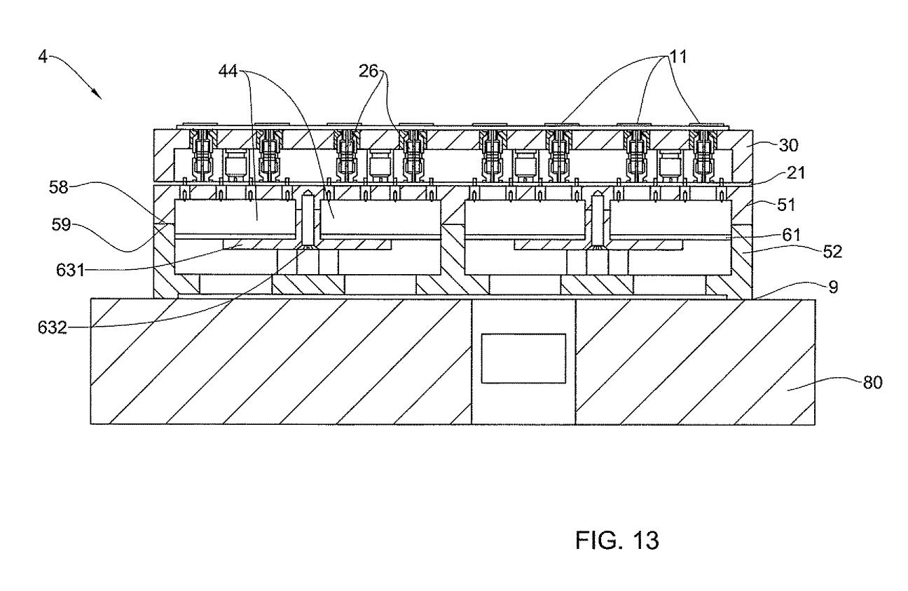

FIG. 13 shows a cross-sectional view of the assembled array antenna structure 4 according to one embodiment of the invention. The quad T/R modules 44 are pressed towards the back side of the first frame 51 with the brackets 631 and the screws 632. This feature provides a relatively large interfacing surface, resulting in direct thermal coupling and therefore good heat conduction between the quad modules 44, together with the RF amplifiers thereinside (not shown), and the first frame 51. Further, the first frame 51 and the second frame 52 are pressed together and form direct thermal coupling, thus providing good heat conduction along their interfacing surfaces 58 and 59. Additionally, the array antenna can be pressed towards the heat exchanger 80, thereby forming thermal communication and good heat conduction through the back side 9 of the interface assembly 50 towards the heat sink 80.

It should be noted that according to this arrangement, the T/R modules 44 are disposed above the primary distribution boards 61 and under the duplexers board 21, thus providing the advantage of direct and short electrical connection between the distribution boards 61 and the T/R modules, and between the T/R modules and the duplexers board 21. Likewise, according to this arrangement the first frame is sandwiched between the active layer 40 and the duplexers board 21, thus allowing the interface assembly 50, comprising first and second frames, 51 and 52, respectively, to encompass the active layer (comprising the T/R modules 44 and the primary distribution board 61), and thereby to provide thermal communication between the T/R modules and the heat exchanger 80. Consequently, heat is removed from the T/R modules 44 primarily upwards into the first frame 51 which is being sandwiched between the active layer and the passive layer (comprising the duplexers board 21). From the first frame heat is further transferred through the second frame 52 into the heat exchanger 80. According to one embodiment, interfacing the first and second frames along the surfaces 58 and 59 can be further enhanced by providing a thermal pad (not shown) between these surfaces. The thermal pad can, for example, be provided by Thermagon Inc. In particular, a pad T-GON™ 800 can be suitable for the purpose of the present invention. The thermal pad can be cut to fit the foot-print of the interfacing surfaces 58 and 59, and be placed between the two frames. Such a pad can provide direct thermal coupling and high thermal conductivity thus supporting heat conduction across the interfacing surfaces 58 and 59. Moreover, the thermal pad can provide electrical conductivity thus improving the RF shielding provided by the frames 51 and 52.

As such, those skilled in the art to which the present invention pertains, can appreciate that while the present invention has been described in terms of preferred embodiments, the conception, upon which this disclosure is based, may readily be utilized as a basis for the designing of other structures systems and processes for carrying out the several purposes of the present invention.

It is to be understood that the phraseology and terminology employed herein are for the purpose of description and should not be regarded as limiting.

Finally, it should be noted that the word “comprising” as used throughout the appended claims is to be interpreted to mean “including but not limited to”.

It is important, therefore, that the scope of the invention is not construed as being limited by the illustrative embodiments set forth herein. Other variations are possible within the scope of the present invention as defined in the appended claims. Other combinations and sub-combinations of features, functions, elements and/or properties may be claimed through amendment of the present claims or presentation of new claims in this or a related application. Such amended or new claims, whether they are directed to different combinations or directed to the same combinations, whether different, broader, narrower or equal in scope to the original claims, are also regarded as included within the subject matter of the present description.

1-37. (canceled)

38. A vertically stacked array antenna structure comprising:
a radiating layer comprising an array of radiating elements;
a passive layer disposed under said radiating layer and having only passive components, wherein at least a part of said passive components includes an array of RF duplexers corresponding to the array of radiating elements;
an active layer disposed under said passive layer and comprising RF amplifiers; and
an interface assembly comprising at least one metallic frame being in direct thermal, coupling with said RF amplifiers, and configured for providing thermal communication of said active layer with a heat exchanger.

39. The vertically stacked array antenna structure of claim 38, further comprising the heat exchanger thermally communicating with said interface assembly.

40. The vertically stacked array antenna structure of claim 38, wherein said plurality of RF amplifiers is in direct thermal coupling with said metallic frame.

41. The vertically stacked array antenna structure of claim 38, wherein said plurality of RF amplifiers are integrated into RF amplifier modules, each RF amplifier module including at least two RF amplifiers.

42. The vertically stacked array antenna structure of claim 41, wherein at least one said RF amplifier module comprises four pairs of RF amplifiers, each pair of the RF amplifiers comprises one transmission RF amplifier and one reception RF amplifier, and said each pair of the RF amplifiers corresponds to one corresponding duplexer.

43. The vertically stacked array antenna structure of claim 38, wherein said interface assembly includes a first metallic frame and a second metallic frame, both metallic frames disposed under said passive layer, and wherein said active layer is encompassed between the first metallic frame and the second metallic frame.

44. The vertically stacked array antenna structure of claim 43, wherein said first metallic frame and said second metallic frame are in direct thermal coupling with each other.

45. The vertically stacked array antenna structure of claim 44, wherein at least one frame selected from said first metallic frame and said second metallic frame has a compartment structure comprising at least one compartment, each compartment defining a cavity in which said RF amplifiers are located substantially thereinside.

46. The vertically stacked array antenna structure of claim 38, further comprising an antenna frame disposed under said radiating layer, said antenna frame having holes passing through the antenna frame for RF interconnections.

47. The vertically stacked array antenna structure of claim 46, wherein the antenna frame has a compartment structure comprising at least one compartment, each compartment defining a cavity in which RF duplexers are located substantially thereinside.

48. The vertically stacked array antenna structure of claim 38, further comprising a distribution network comprising electric connectors configured to establish electric connection between said vertically stacked array antenna structure and external devices, said distribution network configured for distribution of electric signals selected from DC supply signal, control signals, transmission RF signals and Reception RF signals.

49. The vertically stacked array antenna structure of claim 48 wherein said distribution network is arranged within the active layer.

50. The vertically stacked array antenna structure of claim 48 wherein said distribution network is arranged within the interface assembly.

51. The vertically stacked array antenna structure of claim 48 wherein said distribution network is arranged between the active layer and the interface assembly.

52. The vertically stacked array antenna structure of claim 48 wherein said distribution network is arranged under the interface assembly.

53. The vertically stacked array antenna structure of claim 48, wherein said distribution network is implemented on a primary distribution board arranged within said active layer and on a secondary distribution board arranged within the interface assembly, wherein said primary distribution board comprises fuzz buttons for connecting said primary distribution board to said secondary distribution board, and said secondary distribution board comprises electric connectors passing through the heat exchanger, and configured for connecting to external devices.

54. The vertically stacked array antenna structure of claim 43 further comprising a distribution network wherein said distribution network is implemented on a primary distribution board arranged within said active layer and on a secondary distribution board arranged under the second metallic frame, said secondary distribution board further comprises electric connectors passing through the heat exchanger, and configured for connecting to external devices.

55. The vertically stacked array antenna structure of claim 38 wherein said passive layer is interconnected directly to said radiating layer by a first set of RF connectors.

56. The vertically stacked array antenna structure of claim 38 wherein said passive layer is interconnected directly to said active layer by a second set of RF connectors.

57. A method for production of a vertically stacked array antenna structure comprising:
providing a radiating layer comprising an array of radiating elements;
providing a passive layer consisting of passive components, wherein at least a part of said passive components includes an array of RF duplexers corresponding to the array of radiating elements;
disposing said passive layer under said radiating layer;
providing an active layer comprising RF amplifiers;
disposing the active layer under said passive layer;
providing an interface assembly comprising at least one metallic frame;
establishing direct thermal coupling of said metallic frame with said RF amplifiers; and
configuring said interface assembly for providing thermal communication of the active layer with a heat exchanger.
